(19) United States
(12) Patent Application Publication
(10) Pub. No.: US 2010/0330916 A1
(43) Pub. Date: Dec. 30, 2010

(54) INTERFERENCE ELIMINATING CIRCUIT AND SIGNAL TRANSCEIVING SYSTEM EMPLOYING THE SAME

(75) Inventors: MENG-HUNG HSIEH, Tu-Cheng (TW); CHUN-FA LIAO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/508,733

(22) Filed: Jul. 24, 2009

(30) Foreign Application Priority Data
Jun. 29, 2009 (CN) 200910303836.8

(51) Int. Cl. H04B 1/00

(52) U.S. Cl. 455/63.1

(57) ABSTRACT

An interference eliminating circuit for removing an interference signal from a multi-carrier signal includes a training sequence generator, a first multiplier, a second multiplier, a phase shift circuit, a buffer, and an adder. The multi-carrier signal includes a first training sequence. The training sequence generator generates a second training sequence orthogonal to the first training sequence. The first multiplier attaches the second training sequence to the multi-carrier signal to obtain a new multi-carrier signal. The second multiplier attaches the second training sequence to the new multi-carrier signal to obtain the interference signal. The phase shift circuit shifts phase of the interference signal to obtain an adverse signal of the interference signal. The buffer buffers the multi-carrier signals. The adder adds the adverse signal of the interference signal to the buffered multi-carrier signals to remove the interference signal.

### BACKGROUND

1. Technical Field

Embodiments of the present disclosure relate to wireless communications, and more particularly to an interference eliminating circuit and a signal transceiving system employing the same.

2. Description of Related Art

Most wireless communication systems include signal transmitters and signal receivers. When a signal transmitter transmits multi-carrier signals to a signal receiver over a communication channel, the signal receiver must know both start and end points of the multi-carrier signals in order to accurately modulate and demodulate the multi-carrier signals. However, the multi-carrier signals transmitted over the communication channel may be offset because of delays in the communication channel and unmatchable frequencies of the oscillators between the signal transmitter and the signal receiver. Therefore, the offset must be estimated, which improves efficiency of the wireless communication system.

Practically, the multi-carrier signals include high interference signals from other wireless communication systems. If the high interference signals have not been removed before the estimation, accuracy of the estimation is significantly affected and efficiency provided thereby reduced. Therefore, a circuit and a system to overcome the described shortcomings are needed.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of functional modules of one embodiment of a signal transceiving system of the present disclosure; and

FIG. 2 is a detailed schematic diagram of one embodiment of an interference eliminating circuit utilized by a signal transceiving system such as, for example, that of FIG. 1 in accordance with the present disclosure.

### DETAILED DESCRIPTION

As used herein, the term, “multi-carrier signal” is defined as an input signal that may be used to convey electronic information, such as voice or data, to be transmitted, for example by radio or light. The multi-carrier signal, in one embodiment, may be represented as a formula having certain parameters.

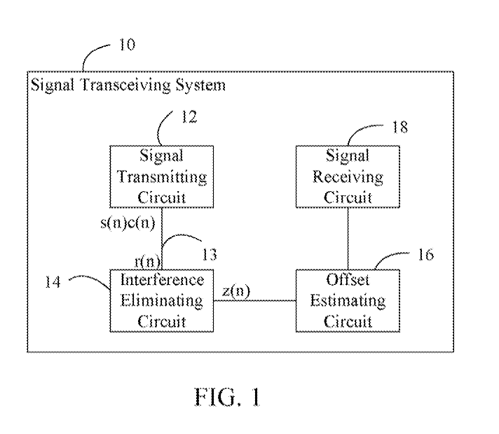

FIG. 1 is a schematic diagram of functional modules of one embodiment of a signal transceiving system 10 of the present disclosure.

The signal transceiving system 10 includes a signal transmitting circuit 12, an interference eliminating circuit 14, an offset estimating circuit 16, and a signal receiving circuit 18. In one embodiment, the signal transmitting circuit 12 transmits a multi-carrier signal s′(n) to the interference eliminating circuit 14, the offset estimating circuit 16, and the signal receiving circuit 18 over a communication channel 13. In one embodiment, the multi-carrier signal may be an orthogonal frequency division multiplexing (OFDM) signal. The communication channel 13 may be the additive white Gaussian noise (AWGN) channel.

In one embodiment, the multi-carrier signal s′(n) is transformed to another multi-carrier signal r(n) when the multi-carrier signal s′(n) reaches the interference eliminating circuit 14 over the communication channel 13. In one embodiment, due to the discrepancy between oscillators of the signal transmitting circuit 12 and the signal receiving circuit 18, frequency offset ε exists between s′(n) and r(n). Due to high interference of another signal transceiving system, r(n) includes an interference signal I(n). The multi-carrier signal r(n) may be expressed by the following formula (1):

$$r ( n ) = {s}^{′} ( n ) {e}^{i \frac{2 π \cdot ɛ \cdot n}{N}} + n ( n ) + I ( n ) , \qquad ( 1 )$$

where i indicates an imaginary number, N indicates a carrier number of the multi-carrier signal s′(n), and n(n) is a series of White Gaussian Noise. In one embodiment, the expectation of n(n) is 0, the variance of n(n) is σₙ², and the real and imaginary parts of n(n) are independent.

The signal transmitting circuit 12 is configured and structured to append a first training sequence c(n) to an original multi-carrier signal s(n) to obtain the multi-carrier signal s′(n), and transmit the multi-carrier signal s′(n) to the interference eliminating circuit 14 over the communication channel 13. In one embodiment, the signal transmitting circuit 12 multiplies the multi-carrier signal s(n) by the first training sequence c(n) to append the first training sequence c(n) to the multi-carrier signal s(n), and as a result, s′(n) is s(n)c(n).

The interference eliminating circuit 14 is configured and structured to receive the multi-carrier signal r(n) over the communication channel 13 and remove the interference signal I(n) in r(n). As the signal transmitting circuit 12 transmits the multi-carrier signal s(n)c(n), the multi-carrier signal r(n) may be expressed as the following formula (2):

r(n)=c(n)e^{i(2π·Δf·n+θ}^{₀}⁾+n(n)+I(n) (2),

where the first training sequence c(n) may be the M-ary phase shift keying (PSK) signal,

$${\vert c ( k ) \vert}^{2} = 1 , Δ f = \frac{ɛ}{N} ,$$

and θ₀ is an initial phase of r(n). Therefore, formula (2) can be transformed to the following formula (3):

r(n)=c(n)e^{i(2π·Δf·n+θ}^{₀}⁾[1+c⁻¹(n)e^{-i(2π·Δf·n+θ}^{₀}⁾n(n)] (3).

Then, if c(n)e^{i(2π·Δf·n+θ}^{₀}⁾·n(n)=v(n)=q(n)+iu(n), where v(n) is also a series of White Gaussian Noise and the variance of v(n) is σₙ²/|c(n)|², then formula (3) can be transformed to the following formula (4):

$$\begin{matrix}\begin{matrix}[ 1 + v ( n ) ] c ( n ) {e}^{i ( 2 π \cdot Δ f \cdot n + {θ}_{0} )} + I ( n ) = [ ( 1 + q ( n ) + i \cdot u ( n ) ] \\ c ( n ) {e}^{i ( 2 π \cdot Δ f \cdot n + {θ}_{0} )} + I ( n ) \\ = \vert R \vert {e}^{iφ} \cdot c ( n ) {e}^{i ( 2 π \cdot Δ f \cdot n + {θ}_{0} )} + I ( n ) ,\end{matrix} & ( 4 ) \\ where R = \sqrt{{( 1 + q ( n ) )}^{2} + {u ( n )}^{2}} \\ and φ = {tan}^{- 1} [ \frac{u ( n )}{1 + q ( n )} ] . & \end{matrix}$$

Here, as r(n) with a high signal-to-noise ratio (SNR) has a low noise power, formula (4) can be approximately transformed to the following formula (5):

$$[ ( 1 + q ( n ) i \cdot u ( n ) ] c ( n ) {e}^{i ( 2 π \cdot Δ f \cdot n + {θ}_{0} )} + I ( n ) = \vert \sqrt{{( 1 + q ( n ) )}^{2} + {u ( n )}^{2}} \vert {e}^{i \cdot {tan}^{- 1} [ \frac{u ( n )}{1 + q ( n )} ]} \cdot c ( n ) {e}^{i ( 2 π \cdot Δ f \cdot n + {θ}_{0} )} + I ( n ) \\ \approx c ( n ) {e}^{i ( 2 π \cdot Δ f \cdot n + {θ}_{0} )} {e}^{i \cdot {tan}^{- 1} [ u ( n ) ]} + I ( n ) \\ \approx c ( n ) {e}^{i ( 2 π \cdot Δ f \cdot n + {θ}_{0} )} {e}^{i \cdot u ( n )} + ( n ) \\ \approx c ( n ) {e}^{i ( 2 π \cdot Δ f \cdot n + {θ}_{0} + u ( n ) )} + I ( n ) , \\ where var ( u ( n ) ) = \frac{1}{2} var ( v ( n ) ) = \frac{{σ}_{n}^{2}}{2} . \qquad ( 5 )$$

According to formula (5), if the White Gaussian Noise is approximate to a phase noise, r(n) can be expressed by the first training sequence c(n) with a shifted phase adding the interference signal I(n), namely:

r(n)=c(n)e^{i(2π·Δf·n+θ}^{₀}^{+u(n))}+I(n) (6).

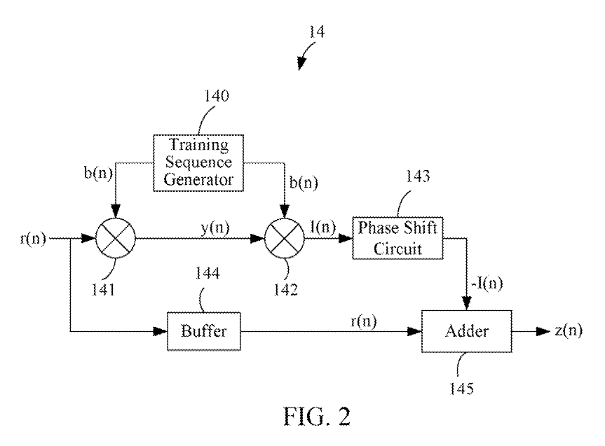

FIG. 2 is a detailed schematic diagram of one embodiment of an interference eliminating circuit utilized by a signal transceiving system such as, for example, that of FIG. 1 in accordance with the present disclosure. In one embodiment, the interference eliminating circuit 14 includes a training sequence generator 140, a first multiplier 141, a second multiplier 142, a phase shift circuit 143, a buffer 144, and an adder 145.

The training sequence generator 140 is configured and structured to generate a second training sequence b(n). In one embodiment, the second training sequence b(n) is orthogonal to the first training sequence c(n) and |b(n)|²=1.

The first multiplier 141 is configured and structured to attach the second training sequence b(n) to the multi-carrier signal r(n) to obtain a new multi-carrier signal y(n). In one embodiment, the first multiplier 141 multiplies the second training sequence b(n) by the multi-carrier signal r(n) to obtain:

y(n)=b(n)·c(n)e^{i(2π·Δf·n+θ}^{₀}^{+u(n))}+b(n)·I(n) (7).

Here, as the second training sequence b(n) is orthogonal to the first training sequence c(n), formula (7) may be transformed to y(n)=b(n)·I(n)

The second multiplier 142 is configured and structured to attach the second training sequence b(n) to the new multi-carrier signal y(n) to obtain the interference signal I(n). In one embodiment, the second multiplier 142 multiplies the second training sequence b(n) by the new multi-carrier signal y(n) to obtain:

y(n)·b(n)=|b(n)|²·I(n)=I(n) (8).

As such, the second multiplier 142 outputs the interference signal I(n).

The phase shift circuit 143 is configured and structured to shift phase of the interference signal I(n) to obtain an adverse signal of the interference signal I(n). As such, the phase shift circuit 143 outputs −I(n).

The buffer 144 is configured and structured to buffer the multi-carrier signal r(n).

The adder 145 is configured and structured to add the adverse signal of the interference signal −I(n) to the buffered multi-carrier signal r(n) to remove the interference signal I(n). In one embodiment, the adder 145 adds r(n) of formula (6) to −I(n) output by the phase shift circuit 143 to obtain:

z(n)=c(n)e^{i(2π·Δf·n+θ}^{₀}^{+u(n))}+I(n)−I(n)=c(n)e^{i(2π·Δf·n+θ}^{₀}^{+u(n))} (9).

Therefore, as shown in formula (9), the interference eliminating circuit 14 has removed the interference signal I(n) in the multi-carrier signal r(n). The interference eliminating circuit 14 now outputs a multi-carrier signal z(n) without the interference signal I(n).

The offset estimating circuit 16 is configured and structured to estimate frequency offset of the multi-carrier signal z(n) output by the interference eliminating circuit 14.

The signal receiving circuit 18 is configured and structured to receive the multi-carrier signal output from the offset estimating circuit 16.

The interference eliminating circuit 14 and the signal transceiving system 10 of the present disclosure employ several simple circuits, such as the first multiplier 141, the second multiplier 142, the phase shift circuit 143, the buffer 144, and the adder 145 to conveniently remove the interference signal I(n) of the multi-carrier signal r(n), thereby effectively increasing estimation accuracy of the offset estimating circuit 16 and improving efficiency of the signal transceiving system 10.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. An interference eliminating circuit for removing an interference signal from a multi-carrier signal, wherein the multi-carrier signal comprises a first training sequence, the interference eliminating circuit comprising:
a training sequence generator configured and structured to generate a second training sequence orthogonal to the first training sequence;
a first multiplier configured and structured to attach the second training sequence to the multi-carrier signal to obtain a new multi-carrier signal;
a second multiplier configured and structured to attach the second training sequence to the new multi-carrier signal to obtain the interference signal;
a phase shift circuit configured and structured to shift phase of the interference signal to obtain an adverse signal of the interference signal;
a buffer configured and structured to buffer the multi-carrier signal; and
an adder configured and structured to add the adverse signal of the interference signal to the buffered multi-carrier signals so as to remove the interference signal.

2. The interference eliminating circuit as claimed in claim 1, wherein the multi-carrier signal comprises an orthogonal frequency division multiplexing signal.

3. The interference eliminating circuit as claimed in claim 2, wherein the first training sequence comprises a M-ary phase shift keying signal.

4. A signal transceiving system, comprising:
a signal transmitting circuit configured and structured to attach a first training sequence to a multi-carrier signal and transmit the multi-carrier signal attached with the first training sequence over a communication channel;
an interference eliminating circuit configured and structured to receive the multi-carrier signal attached with the first training sequence over the communication channel and remove an interference signal therein;
an offset estimating circuit configured and structured to estimate frequency offset of the multi-carrier signal removed the interference signal therein; and
a signal receiving circuit configured and structured to receive the multi-carrier signal output from the offset estimating circuit;
wherein the interference eliminating circuit comprises:
a training sequence generator configured and structured to generate a second training sequence orthogonal to the first training sequence;
a first multiplier configured and structured to attach the second training sequence to the multi-carrier signal to obtain a new multi-carrier signal;
a second multiplier configured and structured to attach the second training sequence to the new multi-carrier signal to obtain the interference signal;
a phase shift circuit configured and structured to shift phase of the interference signal to obtain an adverse signal of the interference signal;
a buffer configured and structured to buffer the multi-carrier signals; and
an adder configured and structured to add the adverse signal of the interference signal to the buffered multi-carrier signals to remove the interference signal.

5. The signal transceiving system as claimed in claim 4, wherein the communication channel comprises an additive white Gaussian noise channel.

6. The signal transceiving system as claimed in claim 4, wherein the multi-carrier signal comprises an orthogonal frequency division multiplexing signal.

7. The signal transceiving system as claimed in claim 6, wherein the first training sequence comprises a M-ary phase shift keying signal.
